(19) United States
(12) Patent Application Publication
(10) Pub. No.: US 2013/0194244 A1
(43) Pub. Date: Aug. 1, 2013

(54) METHODS AND APPARATUSES OF EYE ADAPTATION SUPPORT

(71) Applicant: Zeev Tamir, Haifa (IL)

(72) Inventor: Zeev Tamir, Haifa (IL)

(21) Appl. No.: 13/878,777

(22) PCT Filed: Oct. 11, 2011
(86) PCT No.: PCT/IB11/54468

§ 371 Date: Apr. 11, 2013

(51) Int. Cl. G09G 5/10

(52) U.S. Cl. CPC G09G 5/10
USPC 345/207; 345/87

(57) ABSTRACT

A device for reducing the brightness level of a portion of a display area of an imaging unit. The device comprises a gaze tracking unit adapted to assess eye gazing direction of an observer, a controllable transparency panel adapted to be mounted in front of a display area of an imaging unit and to display a changeable brightness reduction pattern having a original display brightness portion and a darkening portion therearound, and a controller which instructs the controllable transparency panel to change the brightness reduction pattern according to the eye gazing direction in real time so that the location of the original display brightness portion being correlated with the location of at least one fovea of the observer in real time.

### FIELD AND BACKGROUND OF THE INVENTION

The present invention, in some embodiments thereof, relates to eyesight enhancement and, more particularly, but not exclusively, to methods and systems of providing eye adaptation support for viewing imaging apparatuses.

The human eye can function from very dark to very bright levels of light; its sensing capabilities reach across nine orders of magnitude. This means that the brightest and the darkest light signal that the eye can sense are a factor of roughly 1,000,000,000 apart. However, in any given moment of time, the eye can only sense a contrast ratio of one thousand.

A human observer sees colors, distinguishes among slight details or reads, only at certain very narrow viewing angle which is referred to as the Fovea. The central fovea, also known as the foveola, is about 0.2 mm in diameter—where only cone photoreceptors are present and there are virtually no rods. The central fovea consists of very compact cones, thinner and more rod-like than cones elsewhere. Starting at the outskirts of the fovea, however, rods gradually appear, and the absolute density of receptors decreases. This very narrow angle is the only area of a human eye in charge for distinguishing details in day light or artificial (day-level) light. The rods are located at the retinal's periphery outside of the fovea, and at the rest of the retinal area. This assists the eye to see in the dark.

The eye takes approximately 20-30 minutes to fully adapt from day light levels to night light levels and become ten thousand to almost one million times more sensitive than at full daylight. In this process, the eye's perception of color changes as well. However, it takes approximately five minutes for the eye to adapt to bright sunlight from darkness. The cones respond quicker, obtaining more sensitivity when first entering the dark for the first five minutes but the rods take over after five or more minutes, see Sensory Reception Human Vision: Structure and Function of the Human Eye” Encyclopaedia Britannica, vol. 27, 1987.

Changes in the sensitivity of rods and cones in the eye are the major contributors to dark adaptation. Rods are more sensitive to light and take longer to fully adapt to the change in light. Rods, whose photo pigments regenerate more slowly, do not reach their maximum sensitivity for about half an hour. Cones take approximately 9-10 minutes to adapt to the dark.

During the last years, a number of developments were made to reduce eye adaptation period. For example, US Patent Publication number No. 2007/0159478 describes an image display apparatus that includes a luminance sensor to measure a surrounding luminance, a luminance change sensor to sense a change of the surrounding luminance using the measured surrounding luminance, a luminance energy comparator to compare the sensed change of the surrounding luminance with a preset threshold and to compare a maximal eye adaptation in the measured surrounding luminance with a maximal luminance energy of a display, and a luminance adjustment controller to adjust a luminance of the display according to the eye adaptation using the comparison result of the luminance energy comparator.

### SUMMARY OF THE INVENTION

According to some embodiments of the present invention, there is provided a device for reducing the brightness level of a portion of a display area of an imaging unit. The device comprises a gaze tracking unit adapted to assess eye gazing direction of an observer, a controllable transparency panel adapted to be mounted in front of a display area of an imaging unit and to display a changeable brightness reduction pattern having an original display brightness portion and a darkening portion therearound, and a controller which instructs the controllable transparency panel to change the brightness reduction pattern according to the eye gazing direction in real time so that the location of the original display brightness portion being correlated with the location of at least one fovea of the observer in real time.

Optionally, controller instructs the controllable transparency panel to change the brightness reduction pattern so that light passing through the original display brightness portion being projected on at least one fovea of the observer.

Optionally, the controllable transparency panel being substantially transparent in the original display brightness portion.

Optionally, portions peripheral to the original display brightness portion being substantially attenuating.

Optionally, the device further comprises a mechanical adaptor that allows detachably attach the device to the imaging unit.

Optionally, the device is integral part of the imaging unit.

Optionally, the original display brightness portion is sized and shaped so that a projection of an image portion passing therethrough falls on the fovea.

Optionally, the brightness reduction pattern having a transition band placed around the original display brightness portion and having a transparency coefficient between the transparency coefficient of the original display brightness portion and darkening portion.

Optionally, the device further comprises optics for diverting light emitted from the display area along a non straight path having a plurality of non parallel intermediate paths.

Optionally, the gaze tracking unit adapted to detect at least one mounting and removing of the device from an area in front of at least one eye of the observer; wherein the controller instructs at least one of the controllable transparency panel and the imaging unit to change a brightness level according to the detection.

Optionally, the controllable transparency panel comprises at least one directional optical filter.

More optionally, the at least one directional optical filter is controlled to allows light to be projected at the fovea(s) direction with small attenuation while light to be projected at the non-fovea retinal regions with high attenuation.

Optionally, the controllable transparency panel being placed along an optical path between at least one eye of the observer and the display area.

Optionally, the controllable transparency panel is selected from a group consisting of transparent liquid crystal display (LCD) panels, electro-wetting panels, digital micro mirror devices, mechanically movable optical filters having aperture which functions as a center of FOV segment and sized and shaped to pass light at the fovea.

Optionally, the gaze tracking unit comprises an infrared light source and an infrared camera that are placed in front of at least one eye of the observer so that the infrared light source illuminates the at least one eye and the infrared camera images the at least one eye.

Optionally, the gaze tracking unit comprises an infrared light source and an infrared camera and a semi transparent mirror that is placed in front of the controllable transparency panel and set to divert infrared light emitted from the light source toward the eyes of the observer, and an infrared camera and/or infrared detector mounted to capture a reflection of the infrared light from the eye(s) via the semi transparent mirror.

Optionally, the controllable transparency panel comprises an eyepiece is mounted in front of the controllable transparency panel and having eyepiece optics which focuses an image projected through the controllable transparency panel and the pattern on the eye(s) retina(s).

Optionally, the device is an add-on unit to the imaging unit, the gaze tracking unit, the controllable transparency panel, and the controller are housed in handheld housing.

According to some embodiments of the present invention, there is provided a method for operating an adjustable panel which is mounted between a display area of an imaging unit and the eyes of a user. The method comprises assessing eye gazing direction of an observer, calculating instructions to adapt a brightness reduction pattern having an original display brightness portion and a darkening portion therearound on a controllable transparency panel according to the eye gazing direction, the controllable transparency panel being mounted between a display area of an imaging unit and the eyes of the observer, and forwarding the instructions to the controllable transparency panel so that the location of the original display brightness portion is correlated with the location of at least one fovea of the observer in real time so that light passing through the original display brightness portion is projected on at least one fovea.

Optionally, the calculating is performed according to a weight function so that areas of the brightness reduction pattern which are closer to the original display brightness portion are more transparent than areas which are more remote from the original display brightness portion, resulting gradual decrease of brightness from the center of field of view of the retina toward other retinal portions.

Optionally, the forwarding gradually reduces the brightness levels of previous locations of the original display brightness portion.

According to some embodiments of the present invention, there is provided an imaging unit having adjustable brightness level. The imaging unit comprises a gaze tracking unit adapted to assess eye gazing direction of an observer, a display adapted to display an image, and a controller which calculates a changeable brightness reduction pattern having an original display brightness portion and a darkening portion therearound and instructs the display to reduce brightness level in a first image segment which correspond with the darkening portion in real time so that the location of a second image segment, which is surrounded by the first image segment, being correlated with the location of at least one fovea of the observer in real time.

Unless otherwise defined, all technical and/or scientific terms used herein have the same meaning as commonly understood by one of ordinary skill in the art to which to the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an eye adaptation device having a to controllable transparency panel which is set to be placed in front of an imaging apparatus, according to some embodiments of the present invention;

FIG. 2 is an image of a brightness reduction pattern having an original display brightness portion in a selected location in a particular time and darkening area therearound, according to some embodiments of the present invention;

FIG. 3 is a schematic illustration of another eye adaptation device, according to some embodiments of the present invention;

FIG. 4 is a schematic illustration of an additional exemplary eye adaptation device, according to some embodiments of the present invention;

FIGS. 5 and 6 are schematic illustrations of additional exemplary eye adaptation devices having a controllable transparency panel which is not parallel to the display area, according to some embodiments of the present invention;

FIG. 7 is a schematic illustration of an additional exemplary eye adaptation device which uses a directional optical filter for displaying and adjusting the brightness reduction pattern, according to some embodiments of the present invention;

FIG. 8 is a flowchart of a method of operating an adjustable controllable transparency panel which is mounted between a display area of an imaging apparatus and the eyes of a user, according to some embodiments of the present invention; and

FIG. 9 is an image of a brightness reduction pattern having an original display brightness portion which, as the pattern moves, leaves a trace that gradually changes from transparent to attenuation, where brightness decreases toward the tail of the trace, according to some embodiments of the present invention.

### DESCRIPTION OF EMBODIMENTS OF THE INVENTION

The present invention, in some embodiments thereof, relates to eyesight enhancement and, more particularly, but not exclusively, to methods and systems of providing eye adaptation support for viewing imaging apparatuses.

According to some embodiments of the present invention, there are provided methods and devices for reducing the brightness of a portion of an image projected from a display area of an imaging apparatus, such as a night vision apparatus, while the brightness level of another portion remains unchanged or substantially unchanged. The device optionally includes a gaze tracking unit, such as a pupil tracking unit, which is to adapted to detect eye gazing direction of an observer, for example the coordinates of a pupil and/or an eye movement vector. The device further includes a controllable transparency panel, such as a spatial light transparency modulator or a transparent screen, which is adapted to be mounted in front of the display area of the imaging apparatus and to display a changeable brightness reduction pattern having an original display brightness portion and a darkening portion therearound. The device further includes a controller which instructs the controllable transparency panel to change the brightness reduction pattern according to the eye movements in real time so that the location of the original display brightness portion is correlated with the eye movements in real time. In such a manner, the displayed area that is to be projected at the central field of view of the eye, is projected on the eye(s) of the observer via the original display brightness portion without attenuation or with minimal attenuation, and the remaining areas of the image on the display area 99, which are to be projected at the peripheral eye's field of view, are attenuated or substantially attenuated so that the rods at the peripheral regions of the retina, which are primary responsible for night vision, are not exposed to excessive light.

Optionally, the controllable transparency panel is a transparent liquid crystal display panel (LCD), a transparent electro-wetting panel, a mechanically movable optical filter, a directional optical filter, a reflective spatial light modulator such as digital micromirror device, a digital light processing (DLP), and/or and an organic light emitting diode (OLED) panel as further described below.

According to some embodiments of the present invention, there are provided methods and devices for reducing the brightness of a portion of a display area of an imaging apparatus while the brightness level of another portion of the display area remains unchanged or substantially unchanged. In such an embodiment, the device includes a gaze tracking unit adapted to assess eye gazing direction of an observer as described above, a display adapted to display an image, and a controller which calculates a changeable brightness reduction pattern, as outlined above and described below, and instructs the display to reduce brightness level in certain image segments which are to be projected at the peripheral eye's field of view or at the non-fovea retinal areas, at real time so that the less sensitive fovea(s) of the observer will receive sufficient light and the night-adapted retinal periphery will maintain sensitivity, optionally in real time.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to an eye adaptation device 100 having a controllable transparency panel 101 that displays a brightness reduction pattern which is adjusted according to eye movements of a observer and set to be placed along an optical path between the display area 99 of a display of an imaging apparatus, such as an eyepiece of a night vision device, according to some embodiments of the present invention and the eye(s) 98 of the observer. The brightness reduction pattern reduces the brightness of parts of an image projected therethrough, for example the image displayed on the display area 99. The imaging apparatus may be a forward-looking infrared (FLIR) device, starlight amplification viewers, such as a star light amplification tube, infrared viewers, thermal imaging apparatus and/or any other imaging apparatuses having a display area that projects an image for display and/or any display device which designed to provide the user with information, such as control panels and displays of machinery, vehicles, aircraft and ships. The eye adaptation device 100 may be an add-on to the display of an existing imaging apparatus or an integral part on an imaging apparatus. In such embodiments, the eye adaptation device 100 may include one or more mechanical adaptor(s) that allows detachably attaching the eye adaptation device 100 to an imaging apparatus. The mechanical adaptor(s) may be adapted to the size and shape of the eye adaptation device 100. The eye adaptation device 100 may be integrated and/or detachable connected to a helmet or a headband, a hat and/or any other device that allows the mounting thereof in front of the eye(s) of an observer.

As further described below, the eye adaptation device 100 allows fast switching of a human sight between observing the display area 99 of the display of the imaging apparatus and direct night vision, said direct night vision may be natural unassisted eye vision. The eye adaptation device 100 may be adapted for displaying the brightness reduction pattern in front of a binocular display or a monocular display. For clarity, reference is now made interchangeably to an eye adaptation device 100 which is adapted to for a binocular display or a monocular display. The eye adaptation device 100 includes the controllable transparency panel 101, a gaze tracking unit 102 adapted to enable the detection of the eye(s)' 98 gazing direction and movements of the eye(s) 98 of the observer, such as by imaging the eye(s), and a controller 103 that receives the outputs of the gaze tracking unit 102, assess the eye gazing direction by analyzing the relative locations of eye's organs, for example the pupil, the iris, and/or the cornea and controls the controllable transparency panel 101 accordingly; the assessment of the eye(s) gazing direction may be implemented within the a gaze tracking unit 102, the controller 103 or distributed between both units and may utilize any method known in the art of eye(s) gazing direction assessment.

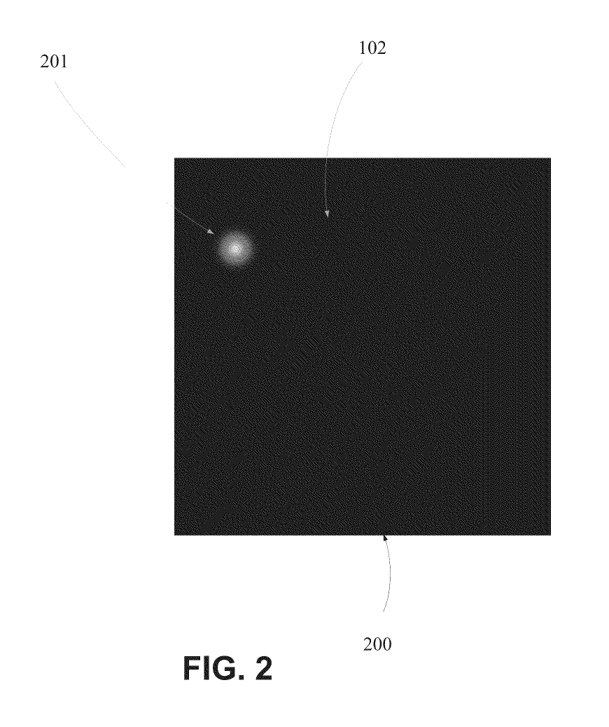

In use, the display area 99 of the imaging apparatus, for example an image panel or the output panel of a light amplification tube or an eyepiece or a viewer of the night vision equipment, displays night vision images or any other image or data display. The controllable transparency panel 101 presents a brightness reduction pattern or a light attenuation pattern that darkens segment(s) of a display of the imaging apparatus, such as 89, while an original display brightness portion, also referred to as a field of view (FOV) segment, remains relatively un-darkened, for example unattenuated, as shown at 88. The original display brightness portion is optionally a portion of the brightness reduction pattern which remains substantially transparent, for example fully transparent or more transparent than the other portions of the pattern, in some of the implementations the original display brightness portion attenuates no more than 80% of the brightness of the image portion which is projected therethrough toward the center of field of view of the eye. In such a manner, the portion of the displayed image which passes therethrough remains with its original brightness level, and/or with a similar brightness level. From another aspect, FIG. 2 is an image of a brightness reduction pattern 200 having an original display brightness portion 201 in a selected location at a particular time instance and darkening area therearound which has a high light attenuation or darkening coefficient that highly attenuates the image or reduces the brightness of an image that is projected therethrough. In such a manner, the image that is displayed on the device area 99 is darkened except of the original display brightness portion. For example, the area of the controllable transparency panel 101 around the original display brightness portion reduces the brightness of respective areas of the to device area 99 to emulate night light levels. The area around the original display brightness portion attenuates the brightness of the portion of the image that passes through this area and projected on the retinal areas of the eye capable of night vision, for example the non-fovea retinal areas, while leaving the original display brightness portion unattenuated or less attenuated. The unattenuated area is a clear area that does not change or minimally change the brightness level of respective segment of the device area 99. In some embodiments, the size and shape of the original display brightness portion is adapted to a distance from the retina(s) and/or to the optics so that its projection on the retina(s) is at the size and the location of the fovea(s), or larger or smaller by a factor from the size of the fovea(s).

From an anatomical point of view, rods at the peripheral regions of the retina, which are primary responsible for night vision, are not exposed to excessive light when the area around the original display brightness portion is attenuated or darkened and the central region that includes cones, which are primary responsible for day vision, is exposed to an amount of light that allows perceiving the image portion projected through the original display brightness portion with its normal brightness level. In such a manner, each part of the retina is displayed with a certain brightness level that allows the retina to function properly and to avoid, or minimize, desensitization (avoid blinding) so as to allow maintaining the eyes' night vision sensitivity following the user watches at the display area 99 of the imaging apparatus.

The controllable transparency panel 101 may be positioned at any location along the optical path between the display area 99 and the eye(s) 98, optionally parallel to the display area 99. For example, the controllable transparency panel 101 may placed adjacent and in parallel to the display area 99 and/or at or near a focal plane of the image.

Optionally, the controllable transparency panel 101 is a transparent liquid crystal display (LCD) panel, for example said transparent liquid crystal display panel may be a monochrome panel, a transparent electro-wetting panel, a mechanically movable optical filter, and/or reflective spatial light modulators such as digital micromirror device or DLP having aperture which functions as an original display brightness portion and sized and shaped so that its projection on the retina fits or approximately fits, or fits by a factor the fovea, and/or any other transparent or semi transparent panel (for example at the original display brightness portion at least 20% of the intensity of the visible light rays which are transmitted thereon is maintained while exiting the panel, while at most of the remaining areas of the controllable transparency panel 101 no more than 1% of the intensity of the visible light rays which are transmitted thereon is maintained while exiting the panel) which is set to display an adjustable brightness reduction pattern such as a real-time controllable spatial light attenuation pattern that is capable to respond and update the pattern at time constants less than or comparable to the time constants of the movements of the eye, such as pattern update within tens of a millisecond or faster, and/or capable to perform pattern changes in about a saccade velocity. For example and without restricting the generality, the controllable transparency panel 101 is L3C09X-8x™ of Seiko™ Epson™ Corporation which the specification thereof is incorporated herein by reference. Such a controllable transparency panel has a wide, instantly controllable, light absorption (transparency or darkness) ratio at each pixel.

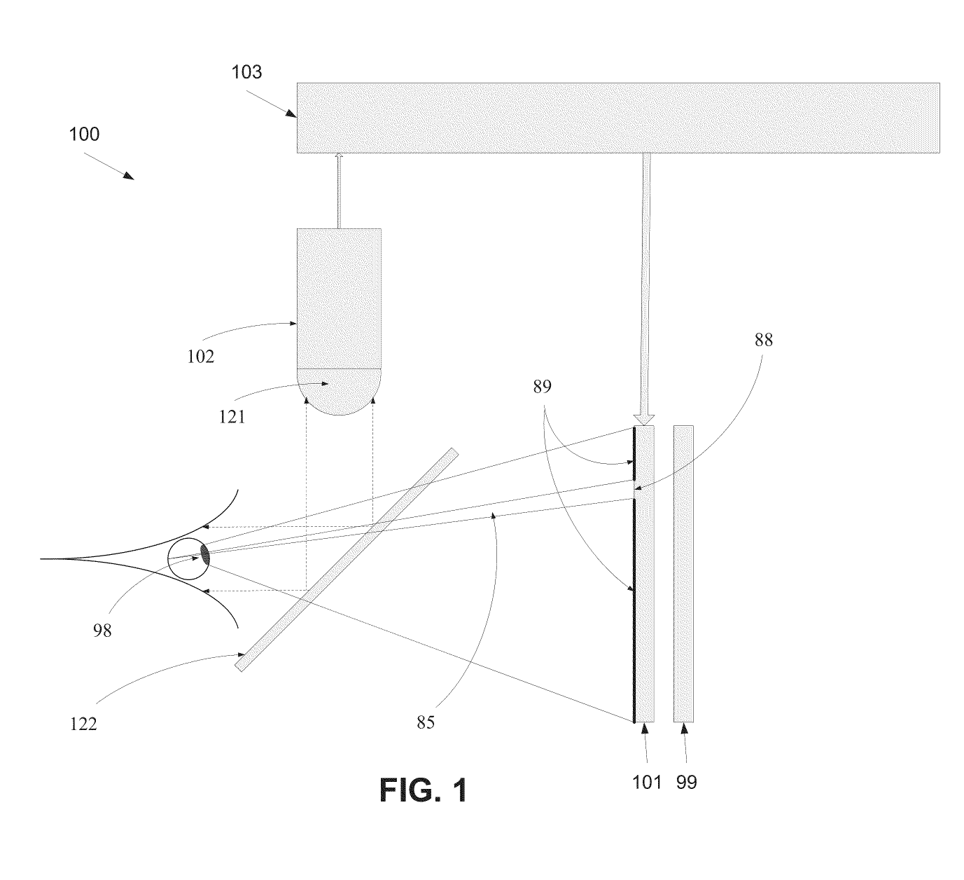

In use, the gaze tracking unit 102 tracks the location of one or more eye features, for example the pupil and/or the iris and/or the cornea and/or the entire eye and forwards the coordinates of the pupil or the direction of sight data to the controller 103, for example as described below. The location of the eye feature is optionally relative to the entire eye and/or to other eye features and/or to the eyepiece and/or to the device. The gazing direction interpretation may be performed within the gaze tracking unit 102 and/or within the controller 103 and/or distributed within both units. The controller 103 instructs an adjustment to the brightness reduction pattern according to the coordinates of the pupil and/or the eye gazing direction and/or the anticipated eye gazing direction so that the location of the original display brightness portion is such that light which passes through it reaches the fovea or at least the fovea or the central parts of the fovea, for example at the center of the binocular and/or the monocular visual field of the user. Optionally, light from a certain segment of the display area 99 passes via the original display brightness portion, further optionally passes through eyepiece optics as known in the art and reaches the fovea. As shown by 85 of FIG. 1, an optical axis between the fovea and a certain segment of the display area 99 passes via the original display brightness portion so that areas around the original display brightness portion reduce the brightness, such as highly attenuate the light, of areas another segment of the display area 99 that is around the said certain segment.

The controller 103 instructions are for generating in real-time a brightness reduction pattern that is correlated with the current and/or predicted position (and/or movement and/or angle of view) of the fovea. In use, the area(s) of the projected image seen by the peripheral areas of the retina is attenuated, preferably highly attenuated, to avoid desensitization of the rods. The peripheral areas are optionally all areas except the fovea or the fovea and adjacent area(s) or the central portions of the fovea. In such a manner, the eye adaptation device 100 dynamically changes the location of the original display brightness portion of the image according to the location of the fovea. In such a manner, the portion of the image that appears on the display area 99 which is to be projected at the central area of the binocular or monocular visual field of view of the eye(s) 98 is projected without attenuation or with minimal attenuation only, as depicted by 85, and the other portions of the image on the display area 99 are projected on the retina attenuated or substantially attenuated.

The exemplary gaze tracking unit 102 depicted in FIG. 1 optionally includes a miniature infrared camera and illuminator 121 and a semi transparent mirror 122, optionally inclined in a 45° angle or in other angles in relation to an optical axis of between the eyes 98 of the observer and the controllable transparency panel 101. The illuminator illuminates the eye 98 with infrared light via the semi transparent mirror 122 and the camera intercepts the reflection of the infrared light from the eye 98 via the semi transparent mirror 122. The images captured by the camera allow tracking pupil and other portions of the eye using known pupil and/or direction of sight tracking algorithms. The gaze tracking unit 102 further include an eye movement module which analyses the movements of the pupil(s) of the eyes 98, for example relative to the display area 99 and/or to the rest of the eyes 98, according to the imaged eye(s). The tracking may be of the pupil(s), the iris(es), and/or the cornea(s). The gaze tracking unit 102 may track pupils (binocular tracking) and/or a single pupil (monocular tracking). The tracking algorithms may be implemented within the gaze tracking unit 102, the controller 103 or divided within both units.

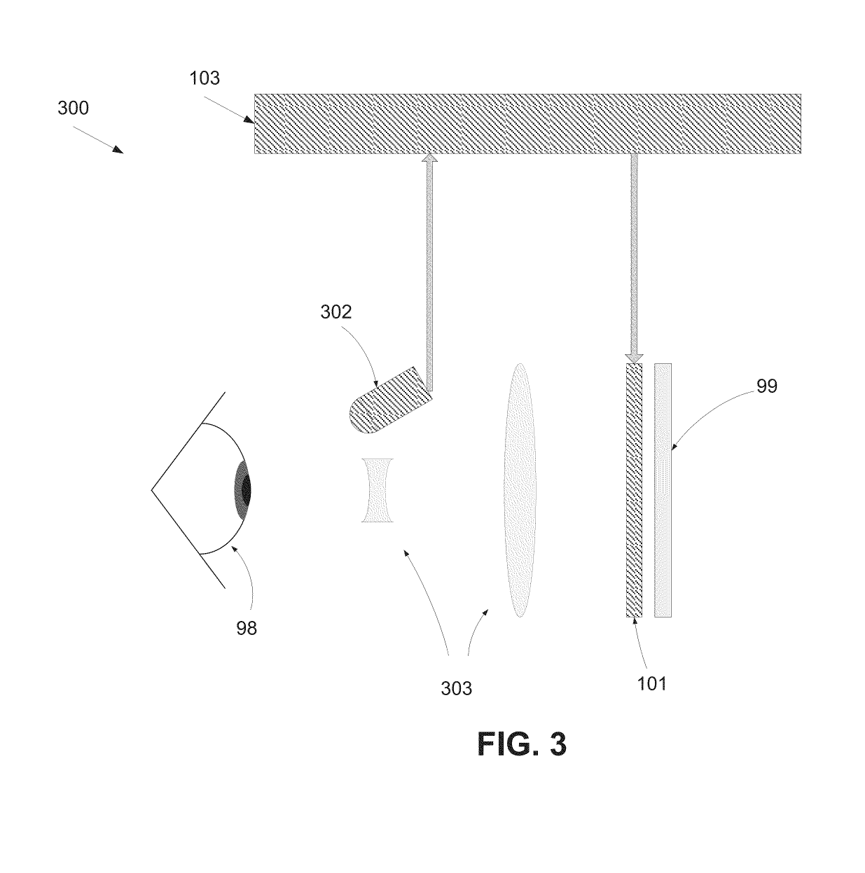

Reference is now made to FIG. 3, which is a schematic illustration of another eye adaptation device 300, according to some embodiments of the present invention. In these embodiments, the controllable transparency panel 101 and the controller 103 are as described above; however, this eye adaptation device 300 includes a gaze tracking unit to 302 that is mounted to image the eye movement directly, without a semi transparent mirror. The gaze tracking unit 302 is placed alongside, or in front of, or behind the optics of an eyepiece 303 which is placed along an optical axis between the point of view of the eyes of the observer and the display area 99. The eyepiece 303 is optionally an existing eyepiece of an imaging apparatus which operates with the display area 99 to facilitate viewing. The embodiments depicted in FIG. 3 are suitable for an eye adaptation device 300 that is integrated into an existing imaging apparatus. In this figure, components of the eye adaptation device 300 are striped. The eyepiece optics 303 may be any eyepiece optics as known in the art.

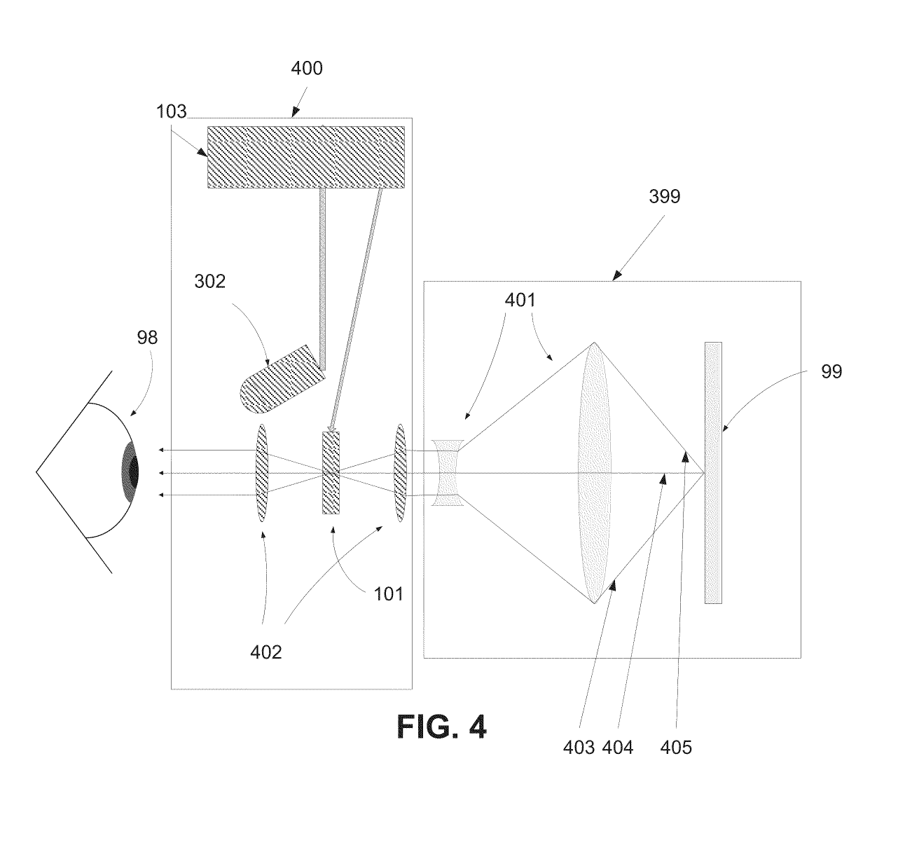

Reference is now made to FIG. 4 which is a schematic illustration of an additional exemplary eye adaptation device 400, according to some embodiments of the present invention. In these embodiments, the controllable transparency panel 101, the controller 103, and the gaze tracking unit 302 are as described above; however, in these embodiments the controllable transparency panel 101 is not adjacent to the display area 99 but rather placed at a focal plane of the projected image in front of the eyepiece optics 401, which is optionally a part of an existing imaging apparatus 399. In such embodiments, the eye adaptation device 400 may be an add-on device having correlation optics 402. Lines 403-405 depict paths of light rays emerging from a single pixel on the display area 99.

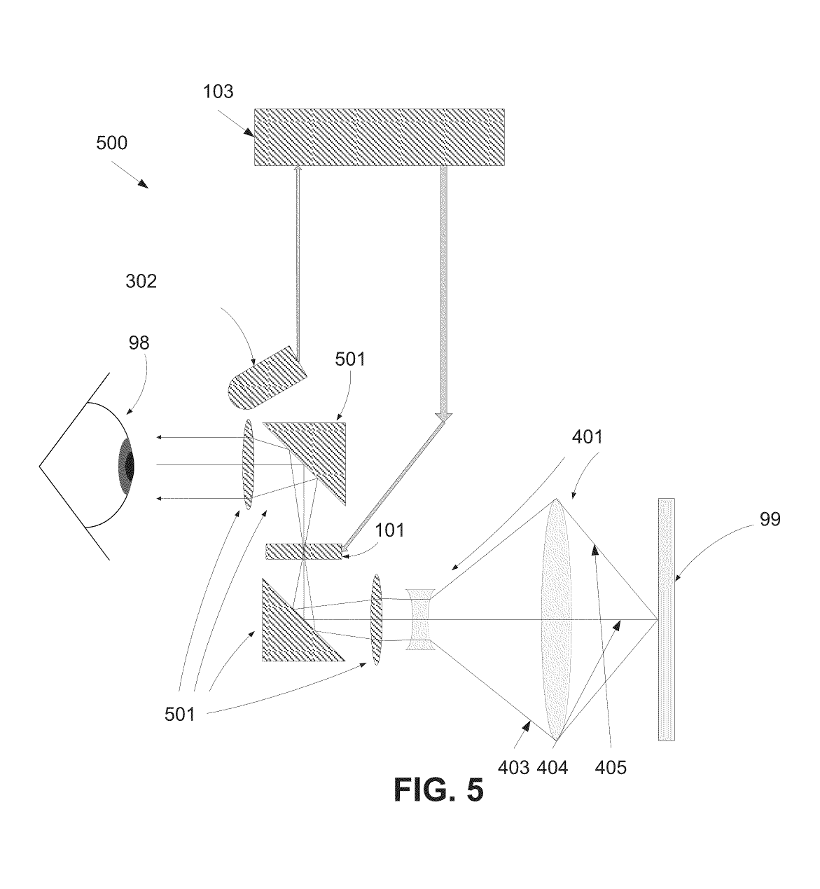

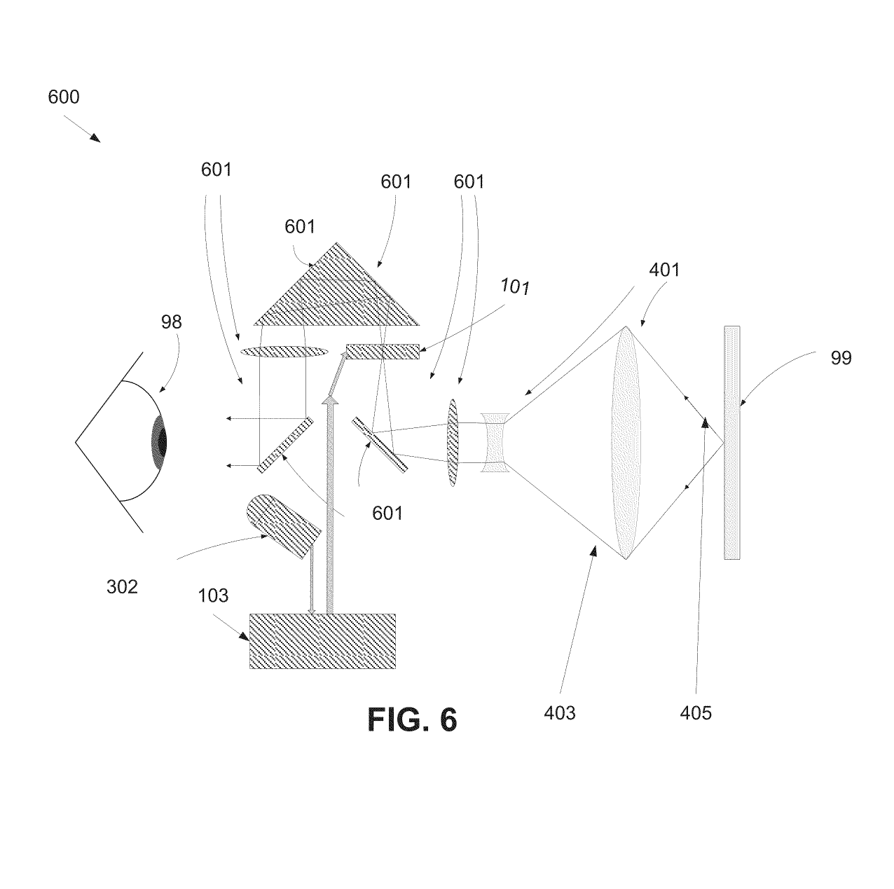

Reference is now made to FIGS. 5 and 6 which are schematic illustrations of additional exemplary eye adaptation devices 500 and 600 wherein the path of light rays from the display area 99 to the eye 98 may be folded, the orientation of the controllable transparency panel 101 may or may not be parallel to the display area 99, for example perpendicular thereto, according to some embodiments of the present invention. In such embodiments, each one of the eye adaptation devices 500 and 600 include optics, optionally with optical components such as prisms and/or mirrors 501, 601, which divert light projected from the display area 99 along a non straight path or folded path which includes a number of non parallel intermediate paths. This optics creates one or more focal planes where the projected image is re-focused. For example, lines 403, 404 and 405 depict paths of light rays emerging from a single pixel on the display area 99. The optics that divert light along non straight path is suitable to be mounted in a housing of a compact eye adaptation device add-on designed for being added to an existing imaging apparatus, for example as an eyepiece extension. This is facilitated as the aforementioned optics diverts the projected image along a non straight path in relatively compact volume. Techniques known in the art for compacting optics and/or folding optics for binoculars, periscopes and/or other devices may be utilized. As depicted in FIGS. 5 and 6, the gaze tracking unit 102 may be placed below and/or above the eye(s) of the observer, optionally alongside the other optical components or in front of or behind the other optical components.

According to some embodiments of the present invention, the gaze tracking unit 102 and/or 302 is set to identify the mounting of eye adaptation device, such as 100, 300, 400, 500, 600 and/or 700, in front of the eyes of the observer and/or the misplacement of the eye adaptation device in relation to the eyes of the observer and/or the removal of the eye adaptation device from being in front of the eyes of the observer; said identification is equivalent to the detection of the approach of the eye(s) of the observer to a viewing position behind the eye adaptation device, such as 100, 300, 400, 500, 600 and/or 700, and the detachment of the eye(s) of the observer from the viewing position behind the eye adaptation device.

The detection may be performed by analyzing the images captured by the camera of the eye adaptation device 100, 300, 400, 500, 600 and/or 700 and detecting the presence and/or absence of a pupil and/or other eye's portions. Optionally, the brightness level of the image displayed on the display area 99 and/or the presentation of the brightness reduction pattern may be determined according to the placing, misplacing, and/or removal of the eye 98. By regulating brightness according to the approaching and/or the detaching of the eye(s) 98 in relation to the eye adaptation device 100, 300, 400, 500, 600 and/or 700, intense light rays are less likely to illuminate the retinal areas around the fovea, reducing the (peripheral) night-vision sensitivity of the eye. Some embodiments of the present invention may maintain the entire controllable transparency panel 101 highly attenuating while no eye(s) 98 is detected in a stable viewing position; only when the eye(s) is identified in a stable viewing position and the direction of sight is identified will the brighter original display brightness portion 88, 201 appear.

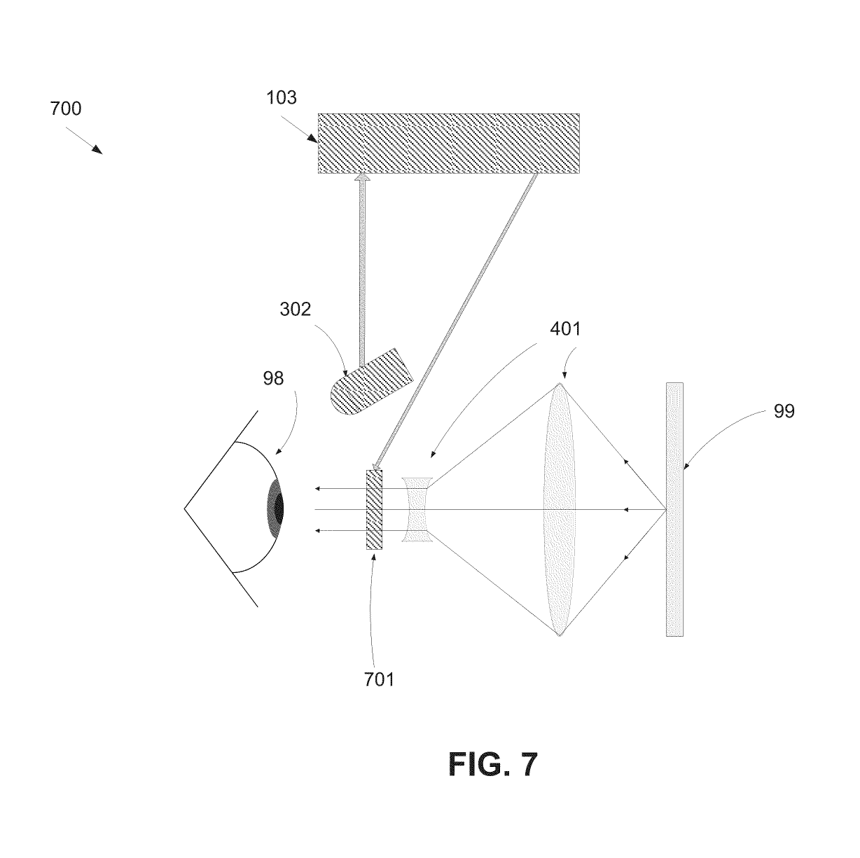

According to some embodiments of the present invention, the controllable transparency panel 101 includes one or more directional optical filters that are capable of attenuating light rays according to their direction of arrival at the directional optical to filters; light rays that arrive from a particular, real-time controllable direction are less attenuated while light rays that arrive from other directions are highly attenuated. The direction of sight of the eye 98 (the center of the field of view direction) is detected at real-time as described above and below; light rays that enter the eye at this direction are projected on the fovea while light rays that enter the eye at other directions are projected on the periphery of the retina outside the fovea. Said directional optical filter(s) is controlled in real-time so that it will minimize the attenuation of light rays passing through it parallel to the current eye sight direction while highly attenuate light rays passing through it at other directions. In such a manner, parts of the image that reach the peripheral areas of the retina are highly attenuated, while the parts of the image that reach the central FOV areas of the retina, such as the fovea, parts of the fovea and/or areas that are adjacent to or surround the fovea, less attenuated. The directional filter may be positioned near the eye or at other locations between the display area 99 and the eye(s). The one or more directional optical filters are optionally as described in international patent application pub. No. WO2008/155767, which is incorporated herein by reference. In such embodiments, the directional filter is an optical element having an array of a plurality of polarizers where attenuation is determined by rotating one or more of the polarizers, for example by 90 degrees, for obtaining a directional pass instead of a directional block. For example, FIG. 7 is a schematic illustration of an additional exemplary eye adaptation device 700 which uses a directional optical filter 701 for displaying and adjusting the brightness reduction pattern, according to some embodiments of the present invention.

According to some embodiments of the present invention, the display area 99 of imagining device is dynamically darkened and/or controlled to generate low brightness image portions according to the calculated brightness reduction pattern that is changed in real time. In such embodiments, the controller 103 forwards the instructions for adjusting the brightness reduction pattern coordinates to a software module that adjusts the brightness of image displayed on the display area 99. The adjustment is optionally calculated according to an image brightness control function, based on instructions from the controller 103. It should be noted that in such embodiments, the display area 99 has a dynamic range with wide interval of light levels so as to allow implementing the outcomes of the image brightness control function directly. Optionally, display panels or spatial light modulators with high contrast are to be implemented as the display area 99. For example, LED matrix backlight LCD, OLED displays, reflective spatial light modulators such as digital micromirror device or DLP or any high contrast display known in the art.

In such embodiments, the controller 103 calculates a changeable brightness reduction pattern having an original display brightness portion, which is similar to the original display brightness portion, and a darkening portion therearound. Based on the brightness reduction pattern, the controller 103 instructs the display of the imaging apparatus to generate image portion with normal brightness at the segment of the display area 99 that is to project light at the fovea, at retinal areas adjacent to the fovea, and/or at the central area of the fovea. This is performed while other image portions are generated with low or very low brightness level(s). The low brightness portions are projected at the night sensitive areas of the retina, where the fovea position is calculated in real-time as described above and below. The image brightness control reduces brightness level in a certain image segment which correspond with the darkening portion in real time so that the location of another image segment, which is surrounded by the certain image segment, is correlated with the location of the fovea(s) of the observer in real time.

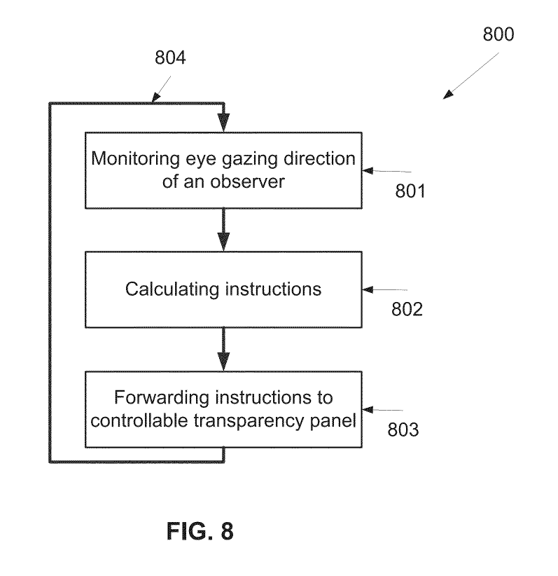

Reference is now also made to FIG. 8, which is a flowchart of a method 800 for operating a controllable transparency panel, such as 101 and/or a directional optical filter 701, according some embodiments of the present invention. First, as shown at 801, gazing direction of a user is monitored, for example using the aforementioned gaze tracking unit 102 and/or 302. Then, as shown at 802, instructions to adapt a brightness reduction pattern having one or more transparent segments displayed on the controllable transparency panel according to the eye(s) gazing direction are calculated. As shown at 803, the instructions are forwarded to the controllable transparency panel 101 and/or the directional optical filter 701 and/or the display area 99 to adjust the brightness reduction pattern in real time. As shown at 804, this process is repeated in real time and/or at a rapid rate relative to the eye movements so as to maintain the original display brightness portion of the brightness reduction pattern in front of the fovea(s) of the eye(s) of the observer and the darkened areas in front of the peripheral regions of the retina.

The methods and the devices above allows users to maintain night eye to adaptation in one or two eyes while using the imaging apparatuses, such as night vision devices, and naked eye vision interchangeably. As the brightness reduction pattern that is presented in front of the projected image and/or used to attenuate portions of the projected image reduces the brightness of the image projected toward the peripheral regions of the retina by more than an order, the retinal rods are not desensitized by impinging light. Keeping the brightness of the display area in front of the fovea and reducing the brightness in front of peripheral regions to low levels comparable with surrounding night light levels enables quick and/or immediate adaptation of the eye to natural night vision.

As described above, the controller 103 calculates instructions for adapting the brightness reduction pattern so that the location of the original display brightness portion is correlated with the current and/or the anticipated fovea(s) positions and/or the monitored eye movements and/or the gazing direction. The location of the original display brightness portion is calculated according to the position of the pupil (i.e. the pupil, the iris and/or the cornea) relative to the entire eye and/or to the display area by imaging the eye(s) and/or by measuring the movements of the eye(s) and/or by utilizing any method known in the art. As a result, the viewing angle of the fovea (the center of the viewing field) is registered. It is then known which spatial directions of light rays that arrive at the eye will hit the fovea (and/or the retinal area adjacent to the fovea and or the central area(s) of the fovea).

As described above, the gaze tracking unit 102 and/or 302 includes a camera for imaging the eye movements. The camera may be a complementary metal oxide semiconductor CMOS or charged coupled device (CCD) camera and/or any other imaging device, for example operating at infrared wavelengths and/or at low light levels and/or sensing the eye using ultrasound devices and/or any imaging method known in the art that does not interfere with the operation of the eye, which is mounted to image the human's eye, iris, pupil and/or retina, transferring the images to the controller 103 which optionally uses a central processing unit (CPU) to extract eye(s) gazing directions and/or movement vectors and/or locations, for example based on eye's viewing-angle determination algorithm(s) and/or the like. The eye(s) gazing direction may be current, anticipated and/or recent gazing direction.

Optionally, a weight function is applied in order to optimize the attenuation effect so that areas which are closer to the original display brightness portion are more transparent than areas which are more remote from the original display brightness portion. Optionally, the brightness reduction pattern may be adjusted for gradual brightness reduction so that the image portions projected at the center of the fovea(s) have the highest brightness and the image brightness gradually decreases as the distance from the center of the fovea(s) increases.

In order to achieve a faster response of the eye tracking system, the gaze tracking unit 102 and/or 302 may sample sub-sets of pixels within the frames captured by the camera. For example, odd lines of one frame may be interlaced with even lines of a subsequent frame to reduce the number of processed pixels to half. In another example, every N^{th} line of a first frame, N^{th}+1 line of a second frame, and N^{th}+2 line of a third frame, and so on are processed so that each frame can be processed faster with temporarily lower resolution.

Optionally, the location of the original display brightness portion is adjusted iteratively.

Optionally, the eye movement vector is calculated according to the mass and angular momentum of the eyeball. In such embodiments, previous historical movement patterns, for example direction and/or velocity are used to estimate near future movement patterns; any prediction algorithm known in the art may be utilized.

Optionally, a current distance between a distance sensor camera and the external surface of the eye(s) is taken into account so that the convex bulge of the cornea is the basis for assessment of direction of center of FOV. Such a distance sensor may be an optical sensor, an ultrasonic sensor, a capacitive sensor and/or the like.

Optionally, the projection of the projected image and/or occasional artificial projected patterns on the retina and/or the eye of the observer are used as angular indicators or angular references for calculating eye gazing direction and/or eye movement vectors; imaging the projected pattern and/or the projected image on the retina and/or on the fovea may be used to enhance the accuracy of the estimation of the fovea position relative to the projected pattern and/or the projected image, as the algorithm receives definitive data regarding the device's projection relative to the fovea. For example, the retina is imaged through the pupil and the fovea, and the yellow spot and/or the macula are identified. This allows identifying a relative and/or an absolute location and/or the angular position of such organ for determining the center of FOV direction. Optionally, the distinct appearance of the fovea and/or other retinal features, and/or the location of the iris and/or other eye features are identified as angular indicators or angular references and used for determining eye view direction and/or eye movement vectors.

According to some embodiments of the present invention, the original display brightness portion of the brightness reduction pattern has edges with a darkening coefficient that is lower than the darkening coefficient of other non original display brightness portion areas of the brightness reduction pattern. Optionally the light attenuation factor of the original display brightness portion increases gradually from the original display brightness portion outwardly. In such embodiments, the projected image brightness around the original display brightness portion decreases gradually as the distance from the original display brightness portion increases, or as the distance from the center of the original display brightness portion increases, easing the transition between the brightness level of the image portion projected via the original display brightness portion and the reduced brightness level of the image portion projected via the area around the original display brightness portion. In such a manner, the eyesight is not interfered with abrupt change of the image brightness. Also, in such a manner a tracking deviation that may occur which results that the location of the brighter portion of the projected image on the retina does not exactly correlate with the current location of fovea for a while, the observer does not experience a sharp decrease in the brightness at the center of FOV.

According to some embodiments of the present invention, the size, the shape, the light attenuation and/or the transparency of the original display brightness portion are dynamically adjusted according to the gazing direction of the eye(s) of the observer. In such a manner, lag in the correlation between the original display brightness portion and fovea may be at least partly compensated. For example, a delay between a change in the eye's view direction, and therefore the fovea position, and the response which is a correlated change of the projected position of the original display brightness portion on to the retina, may cause a short-term undesirable exposure of non-fovea retinal areas that were adapted to night vision to, excessive light levels. As an outcome of such undesirable exposure, these non-fovea retinal areas may reduce their initial sensitivity of natural night-level sensitivity. When the undesirable exposure to day-level light is transitory, for example, exposure of only several milliseconds or only several tens of milliseconds, the reduced sensitivity is minor and these retinal areas rapidly regain their sensitivity. However, for a short period of time, these areas may require slightly elevated levels of brightness in order to perceive adequately.

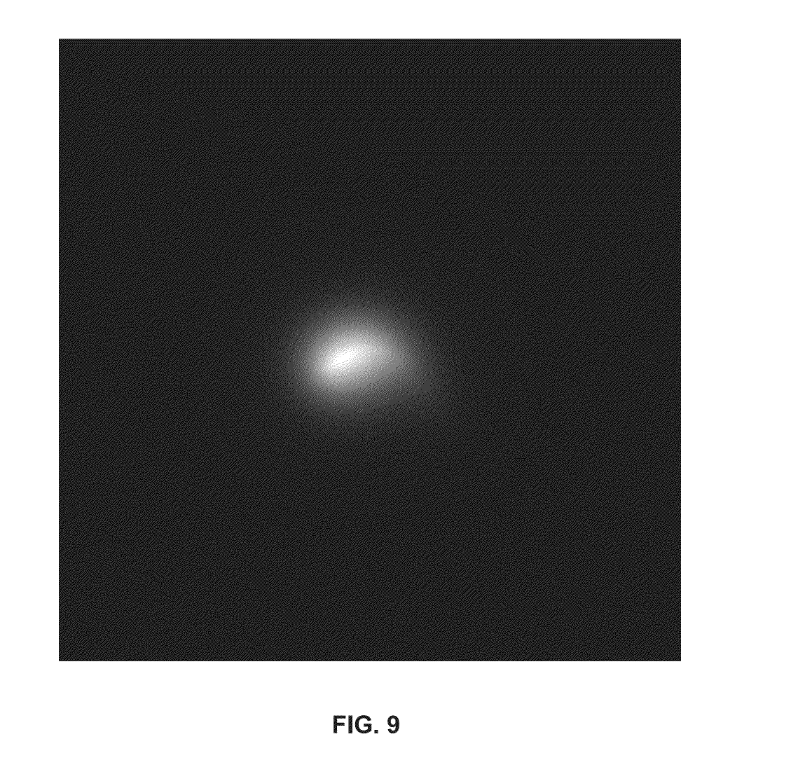

In some embodiments of the present invention, in order to momentarily elevate the levels of brightness that is projected on these non-fovea areas that have just been exposed to elevated light levels, the original display brightness portion as it moves to different areas of the image, returns gradually to the regular high attenuation and/or low image brightness that is characteristic to most of the image area. Such temporal gradual reversion to low transmittance that in some embodiments may last for less that a second or for less than a tenth of a second, may appear as a tail of the original display brightness portion and/or may appear as a teardrop shape, optionally curved, where brightness decreases toward the end of the tail of the shape of the original display brightness portion, for example as depicted in FIG. 9. The actual tail areas may have lower or considerably lower intensities than illustrated in FIG. 9; for example the tail's light attenuation levels may more resemble the peripheral light attenuation levels and/or the dark intensities. The intensities of each of the tail areas may become dimmer with time. The angle and/or the curvature of the tail is optionally adjusted according to the eye movement vector so that the brightness of the light that is projected on retinal areas which may be unintentionally exposed to unattenuated light is momentarily elevated relative to the regular light intensity projected at the non-fovea retinal areas.

It is expected that during the life of a patent maturing from this application many relevant devices and methods will be developed and the scope of the term a computing unit, a controller, a display, a camera, an infrared camera, a controllable transparency panel and a directional optical filter is intended to include all such new technologies a priori.

As used herein the term “about” refers to ±20%.

The terms “comprises”, “comprising”, “includes”, “including”, “having” and to their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof, the term “eye” or “an eye” may include a plurality of eyes such as two or more eyes.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein to interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A device for reducing the brightness level of a portion of a display area of an imaging unit, comprising:
a gaze tracking unit adapted to assess eye gazing direction of an observer;
a controllable transparency panel adapted to be mounted in front of a display area of an imaging unit and to display a changeable brightness reduction pattern having an original display brightness portion and a darkening portion therearound; and
a controller which instructs said controllable transparency panel to change said brightness reduction pattern according to said eye gazing direction in real time so that the location of said original display brightness portion is correlated with the location of at least one fovea of said observer in real time.

2. The device of claim 1, wherein controller instructs said controllable transparency panel to change said brightness reduction pattern so that light passing through the said original display brightness portion being projected on at least one fovea of said observer.

3. The device of claim 1, wherein said controllable transparency panel being substantially transparent in said original display brightness portion.

4. The device of claim 1, wherein portions peripheral to said original display brightness portion being substantially attenuating.

5. The device of claim 1, wherein said device further comprises a mechanical adaptor that allows detachably attach said device to said imaging unit.

6. The device of claim 1, wherein said device is integral part of said imaging unit.

7. The device of claim 1, wherein said original display brightness portion is sized and shaped so that a projection of an image portion passing therethrough falls on said fovea.

8. The device of claim 1, wherein said brightness reduction pattern having a transition band placed around said original display brightness portion and having a transparency coefficient between the transparency coefficient of said original display brightness portion and darkening portion.

9. The device of claim 1, further comprising optics for diverting light emitted from said display area along a non straight path having a plurality of non parallel intermediate paths.

10. The device of claim 1, wherein said gaze tracking unit adapted to detect at least one mounting and removing of said device from an area in front of at least one eye of said observer; wherein said controller instructs at least one of said controllable transparency panel and said imaging unit to change a brightness level according to said detection.

11. The device of claim 1, wherein said controllable transparency panel comprises at least one directional optical filter.

12. The device of claim 11, wherein said at least one directional optical filter is controlled to allows light to be projected at the fovea(s) direction with small attenuation while light to be projected at the non-fovea retinal regions with high attenuation.

13. The device of claim 1, wherein said controllable transparency panel being placed along an optical path between at least one eye of said observer and said display area.

14. The device of claim 1, wherein said controllable transparency panel is selected from a group consisting of transparent liquid crystal display (LCD) panels, electro-wetting panels, digital micro mirror devices, mechanically movable optical filters having aperture which functions as a center of FOV segment and sized and shaped to pass light at the fovea.

15. The device of claim 1, wherein said gaze tracking unit comprises an infrared light source and an infrared camera that are placed in front of at least one eye of said observer so that said infrared light source illuminates the at least one eye and said infrared camera images the at least one eye.

16. The device of claim 1, wherein said gaze tracking unit comprises an infrared light source and an infrared camera and a semi transparent mirror that is placed in front of said controllable transparency panel and set to divert infrared light emitted from said light source toward the eyes of said observer, and an infrared camera and/or infrared detector mounted to capture a reflection of said infrared light from said eye(s) via said semi transparent mirror.

17. The device of claim 1, further comprising an eyepiece is mounted in front of said controllable transparency panel and having eyepiece optics which focuses an image projected through said controllable transparency panel and said pattern on said eye(s) retina(s).

18. The device of claim 1, wherein said device is an add-on unit to said imaging unit, said gaze tracking unit, said controllable transparency panel, and said controller are housed in handheld housing.

19. A method for operating an adjustable panel which is mounted between a display area of an imaging unit and the eyes of a user, comprising:
assessing eye gazing direction of an observer;
calculating instructions to adapt a brightness reduction pattern having an original display brightness portion and a darkening portion therearound on a controllable transparency panel according to said eye gazing direction, said controllable transparency panel being mounted between a display area of an imaging unit and the eyes of said observer; and
forwarding said instructions to said controllable transparency panel so that the location of said original display brightness portion is correlated with the location of at least one fovea of said observer in real time so that light passing through said original display brightness portion is projected on at least one fovea.

20. The method of claim 19, wherein said calculating is performed according to a weight function so that areas of said brightness reduction pattern which are closer to said original display brightness portion are more transparent than areas which are more remote from the said original display brightness portion, resulting gradual decrease of brightness from the center of field of view of the retina toward other retinal portions.

21. The method of claim 19, wherein said forwarding gradually reduces the brightness levels of previous locations of said original display brightness portion.

22. An imaging unit having adjustable brightness level, comprising:
a gaze tracking unit adapted to assess eye gazing direction of an observer;
a display adapted to display an image; and
a controller which calculates a changeable brightness reduction pattern having an original display brightness portion and a darkening portion therearound and instructs said display to reduce brightness level in a first image segment which correspond with said darkening portion in real time so that the location of a second image segment, which is surrounded by said first image segment, being correlated with the location of at least one fovea of said observer in real time.
